(19) United States
(12) Patent Application Publication
(10) Pub. No.: US 2010/0123553 A1
(43) Pub. Date: May 20, 2010

(54) RFID TAG ANTENNA WITH CAPACITIVELY OR INDUCTIVELY COUPLED TUNING COMPONENT

(75) Inventors: Swagata R. Banerjee, North Oaks, MN (US); Robert A. Sainati, Bloomington, MN (US); Ronald D. Jesme, Plymouth, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/621,278

(22) Filed: Nov. 18, 2009

Related U.S. Application Data
(60) Provisional application No. 61/116,176, filed on Nov. 19, 2008.

(51) Int. Cl. H04Q 5/22; H01Q 9/16

(52) U.S. Cl. 340/10.1; 343/747

(57) ABSTRACT

This disclosure describes RFID tags designed to provide improved impedance matching capabilities. An RFID tag may include a radiating component and a tuning component located on different layers of the RFID tag. The radiating component and tuning component are located proximate to one another to provide a proximate coupling (e.g., an inductive and/or capacitive coupling). In one embodiment, at least a portion of the radiating component of a first layer overlaps at least a portion of the tuning component of a second layer, resulting in a proximate coupling. The tuning component may be used for tuning the antenna, e.g., matching an impedance of the radiating element and an IC chip electrically connected to the tuning component. Because the radiating element does not have to be designed to match impedances, the radiating element may be designed to provide better gain, polarization purity, larger radar cross section or other antenna parameters.

### CROSS-REFERENCE TO RELATED APPLICATION

This application claims priority to U.S. Provisional Patent Application No. 61/116,176, filed Nov. 19, 2008, the disclosure of which is incorporated by reference herein in its entirety.”

### TECHNICAL FIELD

This disclosure relates to radio frequency identification (RFID) systems for article management and, more specifically, to RFID tags.

### BACKGROUND

Radio-frequency identification (RFID) technology has become widely used in virtually every industry, including transportation, manufacturing, waste management, postal tracking, airline baggage reconciliation, and highway toll management. An RFID system may be used to prevent unauthorized removal of articles from a protected area, such as a library or retail store, or as a mechanism for managing a plurality of articles.

An RFID system often includes at least one RFID interrogator, often referred to as a “reader,” to interrogate RFID tags to retrieve information from the RFID tags. Each of the RFID tags usually includes information that uniquely identifies the article to which it is affixed. The RFID tags may also include other information associated with the article. The article may be a book, a manufactured item, a vehicle, an animal or individual, or virtually any other tangible article. To detect a tag, the RFID reader outputs RF signals through an antenna to create an electromagnetic field. The field activates RFID tags within a read range of the RFID reader. In turn, the tags produce a characteristic response. In particular, once activated, the tags communicate using a pre-defined protocol, allowing the RFID reader to receive the identifying information from one or more tags in the field.

RFID tags for use in such RFID systems typically include an antenna and an RFID integrated circuit (IC) chip. The antenna may, for example, be made from an electrically conductive trace formed on a substrate. The trace forming the antenna may have bonding pads or other connection points for the IC chip. To improve transfer of the RF signals from the reader to the RFID tag antenna and from the RFID tag antenna to the reader, and thereby increase the read range, the antenna may be designed such that an impedance of the antenna matches an impedance of the IC chip. In other words, RFID tags are designed to provide a conjugate impedance match between the IC chip and the antenna. Designing the antenna to match the impedance of the IC chip may be difficult, in part due to the desire to keep a size of the antenna reasonable and usually as small as possible.

### SUMMARY

This disclosure describes RFID tags designed to provide improved impedance matching capabilities. An RFID tag designed in accordance with the techniques of this disclosure includes a radiating component and a tuning component that are located on different layers of the RFID tag. At least a portion of the radiating component and the tuning component overlap, resulting in capacitive and/or inductive coupling. As such, the tuning component provides a mechanism for coupling an IC chip to the radiating component of the RFID tag. Additionally, the tuning component may be used for tuning the antenna, e.g., matching an impedance of the radiating element and an impedance of the IC chip. As such, the radiating element may be designed to provide better gain, polarization purity, larger radar cross section or other parameter, which may degrade when forming the radiating component to include meanders, arched segments or the like.

In one embodiment, a radio frequency identification (RFID) tag includes a radiating component formed on a first layer of a substrate. The radiating component includes a straight dipole segment and a loop segment that is electrically coupled to the straight dipole segment. The RFID tag also includes a tuning component formed on a second layer of the substrate. At least a portion of the tuning component substantially overlaps a portion of the radiating component of the first layer of the substrate to couple to the radiating component. Additionally, the RFID tag includes an integrated circuit (IC) that electrically couples to the tuning component.

In another embodiment, an antenna for a radio frequency identification (RFID) tag includes a radiating component formed on a first layer of a substrate. The radiating component includes a straight dipole segment and a loop segment that is electrically coupled to the straight dipole segment. The RFID tag also includes a tuning component formed on a second layer of the substrate. The tuning component electrically couples to the radiating component of the first layer of the substrate.

The details of one or more embodiments are set forth in the accompanying drawings and the description below. Other features, objects, and advantages of the embodiments will be apparent from the description and drawings, and from the claims.

### BRIEF DESCRIPTION OF DRAWINGS

FIG. 1 is a block diagram illustrating a radio frequency identification (RFID) system for managing a plurality of articles.

FIGS. 2A-2C are schematic diagrams illustrating an example multi-layer RFID tag that includes a straight radiating component that capacitively couples to a straight tuning component.

FIGS. 3A-3C are schematic diagrams illustrating an example multi-layer RFID tag that includes a straight radiating component that inductively couples to a tuning loop.

FIGS. 4A-4C are schematic diagrams illustrating an example multi-layer RFID tag that includes a radiating component that includes a straight segment and a loop segment that capacitively couples to a straight tuning component.

FIGS. 5A-5C are schematic diagrams illustrating an example multi-layer RFID tag that includes a radiating component that includes a straight segment and a loop segment that inductively couples to a tuning loop.

FIGS. 6A and 6B are schematic diagrams illustrating an example RFID tag that includes a loop radiating component that capacitively couples to an arc-shaped tuning component.

FIGS. 7A and 7B are graphs showing the impedance of several RFID tags over the 900 to 930 MHz range.

FIG. 8 is a graph illustrating radiation characteristics of the various RFID tag designs.

FIG. 9 is a graph comparing example fields radiated by the RFID tag of FIG. 3 and a straight dipole antenna.

FIG. 10 is a graph illustrating example fields radiated by the RFID tag of FIG. 5 and a single-layer modified dipole antenna.

FIGS. 11A and 11B are graphs demonstrating the impedance of the RFID tag of FIG. 6 and a reference RFID tag that includes a loop antenna.

### DETAILED DESCRIPTION

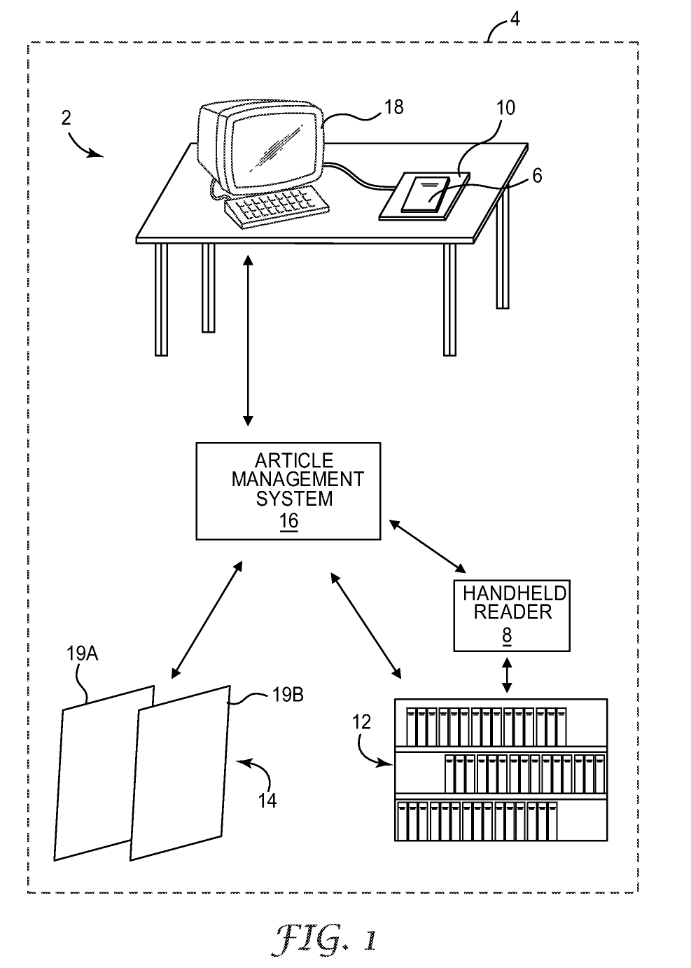

FIG. 1 is a block diagram illustrating an RFID system 2 for managing a plurality of articles. In the example illustrated in FIG. 1, RFID system 2 manages a plurality of articles within an area 4. For purposes of the present description, area 4 will be assumed to be a library and the articles will be assumed to be books or other articles to be checked out. Although the system will be described with respect to managing books or other articles within area 4 to track locations of the articles within area 4 and/or detect checked-in RFID tags to prevent the unauthorized removal of articles from area 4, it shall be understood that the techniques of this disclosure are not limited in this respect. For example, RFID system 2 could also be used to determine other kinds of status or type information without departing from the scope of this disclosure. Moreover, the techniques described herein are not dependent upon the particular application in which RFID system 2 is used. RFID system 2 may be used to manage articles within a number of other types of environments. RFID system 2 may, for example, be used to manage articles within a corporation, a law firm, a government agency, a hospital, a bank, a retail store or other facility.

Each of the articles within area 4, such as book 6, may include an RFID tag (not shown in FIG. 1) attached to the respective article. The RFID tags may be attached to the articles with a pressure sensitive adhesive, tape or any other suitable means of attachment. The placement of RFID tags on the respective articles enables RFID system 2 to associate a description of the article with the respective RFID tag via RF signals. For example, the placement of the RFID tags on the articles enables one or more interrogation devices of RFID system 2 to associate a description or other information related to the article. In the example of FIG. 1, the interrogation devices of RFID system 2 include a handheld RFID reader 8, a desktop reader 10, a shelf reader 12 and an exit control system 14. Handheld RFID reader 8, desktop reader 10, shelf reader 12 and exit control system 14 (collectively referred to herein as “the interrogation devices”) may interrogate one or more of the RFID tags attached to the articles by generating and transmitting RF interrogation signals to the respective tags via an antenna. An RFID tag includes an antenna that receives the interrogation signal from one of the interrogation devices. If a field strength of the interrogation signal exceeds a read threshold, the RFID tag is energized and responds by radiating an RF response signal, a process sometimes referred to as backscattering. That is, the antenna of the RFID tag enables the tag to absorb energy sufficient to power an IC chip coupled to the antenna. Typically, in response to one or more commands contained in the interrogation signal, the IC chip remodulates the interrogation signal to drive the antenna of the RFID tag to output the response signal to be detected by the respective interrogation device. The response signal may include information about the RFID tag and/or its associated article. In this manner, interrogation devices interrogate the RFID tags to obtain information associated with the articles, such as a description of the articles, a status of the articles, a location of the articles, or the like.

Desktop reader 10 may, for example, couple to a computing device 18 for interrogating articles to collect circulation information. A user (e.g., a librarian) may place an article, e.g., book 6, on or near desktop reader 10 to check-out book 6 to a customer or to check-in book 6 from a customer. Desktop reader 10 interrogates the RFID tag of book 6 and provides the information received in the response signal from the RFID tag of book 6 to computing device 18. The information may, for example, include an identification of book 6 (e.g., title, author, or book ID number), a date on which book 6 was checked-in or checked-out, and a name of the customer to whom the book was checked-out. In some cases, the customer may have an RFID tag (e.g., badge or card) associated with the customer that is scanned in conjunction with, prior to or subsequent to the articles which the customer is checking out.

As another example, the librarian may use handheld reader 8 to interrogate articles at remote locations within the library, e.g., on the shelves, to obtain location information associated with the articles. In particular, the librarian may walk around the library and interrogate the books on the shelves with handheld reader 8 to determine what books are on the shelves.

The shelves may also include an RFID tag that may be interrogated to indicate which shelves particular books are on. In some cases, handheld reader 8 may also be used to collect circulation information. In other words, the librarian may use handheld reader 8 to check-in and check-out books to customers.

Shelf reader 12 may also interrogate the books located on the shelves to generate location information. In particular, shelf reader 12 may include antennas along the bottom of the shelf or on the sides of the shelf that interrogate the books on the shelves of shelf reader 12 to determine the identity of the books located on the shelves. The interrogation of books on shelf reader 12 may, for example, be performed on a weekly, daily or hourly basis.

The interrogation devices may interface with an article management system 16 to communicate the information collected by the interrogations to article management system 16. In this manner, article management system 16 functions as a centralized database of information for each article in the facility. The interrogation devices may interface with article management system 16 via one or more of a wired interface, a wireless interface, or over one or more wired or wireless networks. As an example, computing device 18 and/or shelf reader 12 may interface with article management system 16 via a wired or wireless network (e.g., a local area network (LAN)). As another example, handheld reader 8 may interface with article management system 16 via a wired interface, e.g., a USB cable, or via a wireless interface, such as an infrared (IR) interface or Bluetooth™ interface.

Article management system 16 may also be networked or otherwise coupled to one or more computing devices at various locations to provide users, such as the librarian or customers, the ability to access data relative to the articles. For example, the users may request the location and status of a particular article, such as a book. Article management system 16 may retrieve the article information from a database, and report to the user the last location at which the article was located or the status information as to whether the article has been checked-out. In this manner, RFID system 2 may be used for purpose of collection, cataloging and circulating information for the articles in area 4.

In some embodiments, an interrogation device, such as exit control system 14, may not interrogate the RFID tags to collect information, but instead to detect unauthorized removal of the articles from area 4. Exit control system 14 may include lattices 19A and 19B (collectively, “lattices 19”) which define an interrogation zone or corridor located near an exit of area 4. Lattices 19 include one or more antennas for interrogating the RFID tags as they pass through the corridor to determine whether removal of the article to which the RFID tag is attached is authorized. If removal of the article is not authorized, e.g., the book was not checked-out properly, exit control system 14 initiates an appropriate security action, such as sounding an audible alarm, locking an exit gate or the like.

RFID system 2 may, in some instances, be configured to operate in an ultra high frequency (UHF) band of the RF spectrum, e.g., between 300 MHz and 3 GHz. In one exemplary embodiment, RFID system 2 may be configured to operate in the UHF band from approximately 900 MHz to 930 MHz. RFID system 2 may, however, be configured to operate within other portions of the UHF band, such as around 868 MHz (i.e., the European UHF band) or 955 MHz (i.e., the Japanese UHF band). Operation within the UHF band of the RF spectrum may provide several advantages including, increased read range and speed, lower tag cost, smaller tag sizes and the like.

As mentioned above, the RFID tags for use in such applications include an antenna and an IC chip. To improve transfer of RF energy between the interrogator and the RFID tag, an impedance of the antenna should be substantially tuned to an impedance of the IC chip. In other words, RFID tags are designed to provide a conjugate impedance match between the IC chip and the antenna. Conjugately matching the impedances of the antenna and the IC chip, sometimes referred to as “matching” or “tuning”, results in improved read performance, e.g., read range.

To keep IC chip size and cost down, no attempt is typically made to alter the impedance of the IC chip to make it compatible with the impedance of the antenna. As such, the antenna is typically designed such that the impedance of the antenna substantially matches the impedance of the IC chip. Designing the antenna to match the impedance of the IC may be difficult in part due to the desire to keep a size of the antenna small, thereby keeping the size of the overall RFID tag small. To adjust the impedance of the antenna for tuning, a radiating component of the antenna (e.g., the conductive traces forming the antenna) may be designed to include features such as meanders, arched segments, tuning loops and the like.

Forming the antenna to include such features may tune an impedance of the antenna close to the desired impedance and keep the size of the antenna to within reason. However, forming the antenna to include such features may result in degradation of other antenna parameters. For example, designing the radiating component of the antenna to include meanders, arched segments and tuning loops may result in degradation of gain, radiation pattern shape, efficiency and polarization purity. Moreover, designing the antenna to include such features may result in a lack of implementation flexibility. For example, impedance of IC chips from different vendors, and even from the same vendor, may vary significantly. As such, designing the radiating component of the antenna to include meanders, arched segments and tuning loops may limit the flexibility of using the antenna with different IC chips.

Additionally, designing the radiating component of the antenna to include meanders, arched segments and tuning loops may limit the flexibility in terms of antenna design.

An RFID tag designed in accordance with the techniques of this disclosure provides impedance matching capabilities while overcoming some or all of the drawbacks described above. In particular, an RFID tag may be designed to include an antenna that is formed from a radiating component and a tuning component. The radiating component and the tuning component may be located on different layers of a multi-layer RFID tag and couple to one another via a proximal coupling. The proximal coupling may, for example, be a capacitive and/or inductive coupling. The tuning component may provide at least some of the tuning capabilities to substantially match an impedance of the antenna to an impedance of the IC chip. As such, the radiating component may be designed to provide better gain, radiation pattern shape, efficiency, polarization purity, larger radar cross section or other parameter that may degrade when the radiating component is designed to include to meanders, arched segments or the like. Additionally, the RFID tags designed in accordance with the techniques of this disclosure provide improved implementation flexibility. For example, the same antenna may be used with IC chips having different impedances by adjusting the tuning component.

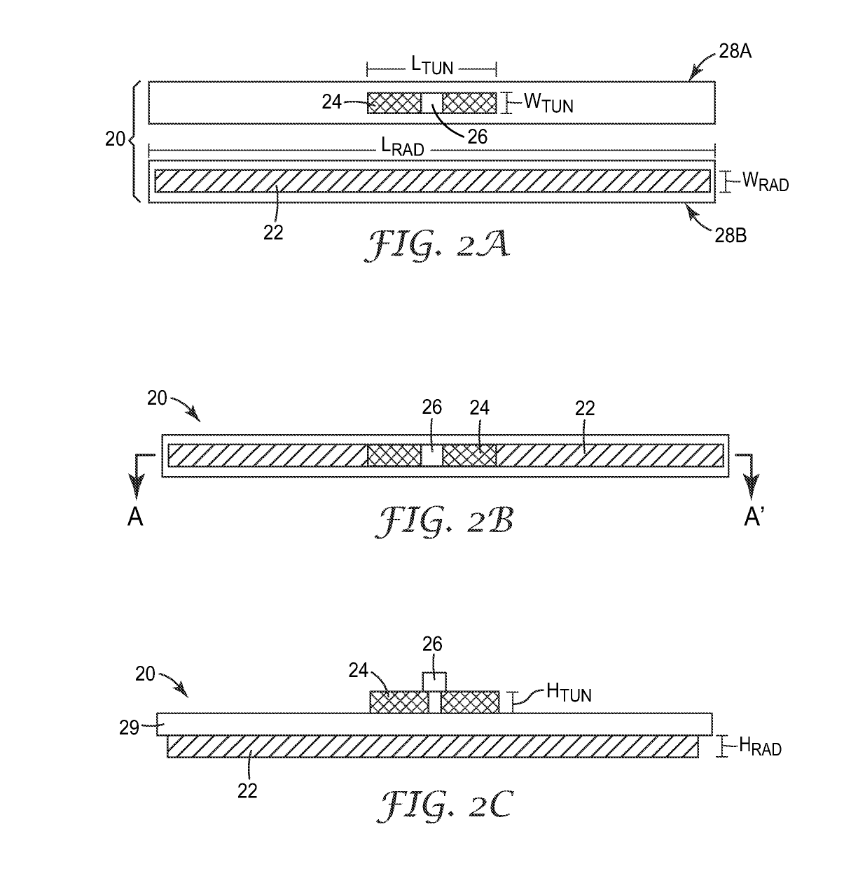

FIGS. 2A-2C are schematic diagrams illustrating an example RFID tag 20 that includes a radiating component 22 that capacitively couples to a tuning component 24. FIG. 2A is an exploded view of RFID tag 20, FIG. 2B is a top view of RFID tag 20 and FIG. 2C is a cross section view of RFID tag 20 from A to A′. As illustrated in the exploded view of RFID tag 20 of FIG. 2A, RFID tag 20 includes a first layer 28A that includes tuning component 24 and a second layer 28B that includes radiating component 22. In one embodiment, radiating component 22 may be formed on a first side of a substrate 29 and tuning component 24 may be formed on a second, e.g., opposite, side of substrate 29. In another embodiment, radiating component 22 and tuning component 24 may formed on separate substrates. Substrate 29 may comprise any dielectric material, and, in one example, may be a thin, plastic substrate. Radiating component 22 and tuning component 24 may, in some instances, be formed using various fabrication techniques. Radiating component 22 and tuning component 24 may, for example, be printed onto substrate 29. Alternatively, a conductive layer, such as copper, aluminum, or other conductive material, may be deposited on substrate 29, e.g., via chemical vapor deposition, sputtering, or any other depositing technique, and radiating component 22 and tuning component 24 may be shaped via etching, photolithography, masking, or similar technique.

In the example RFID tag 20 illustrated in FIGS. 2A-2C, radiating component 22 is a straight dipole element that has a length L_{RAD} and a width W_{RAD}. Tuning component 24 is a straight tuning element that has a length L_{TUN} and a width W_{TUN}. Radiating component 22 and tuning component 24 are arranged such that radiating component 22 and tuning component 24 are coupled via a proximal coupling. For example, radiating component 22 and tuning component 24 may be arranged such that there is substantial overlap between a portion of radiating component 22 and tuning component 24. In the example top view illustrated in FIG. 2B, there is a substantial overlap between a portion of the length and width of radiating component 22 of the first layer and the length and width of tuning component 24 of the second layer. In other words, when viewed from the top, the portion of the length and width of radiating component 22 is directly above the length and width of tuning component 24.

The overlap between tuning component 24 and radiating component 22 provides capacitive coupling between tuning component 24 and radiating component 22 for transferring RF energy, e.g., RF signals, between radiating component 22 and an IC chip 26 that is electrically coupled to the tuning component 24. As will be described in further detail below, the capacitive coupling may also be used as the tuning element. IC chip 26 may be electrically coupled to tuning component 24 via one or more feedpoints, e.g., bonding pads or other means for interconnection. IC chip 26 may be bonded to the feedpoints using flip chip bonding, wire bonding or the any other attachment mechanism.

The length L_{RAD} of radiating component 22 may, for example, be greater than approximately 100 mm (about 4 inches), and more preferably between approximately 130 mm and 180 mm (between about 5 and 7 inches), and even more preferably approximately 165 mm (slightly over 6.5 inches). The width W_{RAD} of the radiating component 22 may be less than approximately 4 mm (about 0.15 inches), and more preferably approximately 1 mm (about 0.04 inches). The length L_{TUN} of tuning component 24 may be between approximately 10 mm and 50 mm (between about 0.4 and 2.0 inches), and more preferably between approximately 20 mm and 40 mm (between about 0.79 and 1.57 inches). The width W_{TUN} of the tuning component 24 may be less than approximately 4 mm (about 0.15 inches), and more preferably approximately 1 mm (about 0.04 inches). In one embodiment, one or more conductive traces that form radiating component 22 and/or tuning component 24 may have a minimum trace width of a selected manufacturing process, e.g., approximately 1 mm. Although in the example illustrated in FIGS. 2A-2C radiating component 22 and tuning component 24 have substantially the same widths, the width W_{TUN} of tuning component 24 may be wider or narrower than the width W_{RAD} of radiating component 22.

The long, narrow aspect of radiating component 22 may allow RFID tag 20 to be concealed, i.e., rendered covert, on or within the article while still allowing RFID tag 20 to be interrogated even when partially covered by some object. For example, RFID tag 20 may be placed within a gutter of a book or on an inside portion of a spine of the book to conceal RFID tag 20 from an observer. RFID tag 20 may, however, still be interrogated when a hand of a person holding the book is partially covering RFID tag 20.

As described above, arranging radiating component 22 and tuning component 24 such that there is substantial overlap between a portion of radiating component 22 and tuning component 24 results in capacitive coupling between radiating component 22 and tuning component 24. In this manner, tuning component 24 functions as a mechanism for interconnecting radiating component 22 with IC chip 26. In one example, a conductive trace forming tuning component 24 may act as a first capacitive plate and the portion of a conductive trace of the radiating component 22 that overlaps the tuning component may act as a second conductive plate. An electric field exists between the overlapping conductive traces to provide the capacitive coupling between tuning component 24 and radiating component 22. In general, the more overlapping surface area between radiating component 22 and tuning component 24, the larger the tuning capacitance. The amount of overlap may be controlled, for example, by adjusting a length and/or width of tuning component 24 or positioning of tuning component 24 with respect to the radiating component 22.

Additionally, the distance between the overlapping portions of radiating component 22 and tuning component 24, e.g., the thickness of substrate 29, may further be used to control the tuning capacitance. Although the predominant coupling between radiating component 22 and tuning component 24 of RFID antenna 20 is capacitive, the coupling may include at least some inductive coupling as well.

The length L_{TUN} and the width W_{TUN} of tuning component 24 may also be adjusted to provide improved impedance matching between an impedance of radiating component 22 and IC chip 26. Matching an impedance of the antenna to the impedance of IC chip 26 improves transfer of RF energy between the interrogator and the RFID tag. Generally, IC chip 26 has a complex impedance with a resistance (i.e., real part of the impedance) and a negative reactance (i.e., imaginary part of the impedance). The reactance is typically a large negative value due to the input circuitry of the IC. Thus, to achieve conjugate matching, tuning component 24 may be designed to provide the antenna with an equivalent resistance and equal and opposite positive reactance. In particular, the length L_{TUN} and the width W_{TUN} of tuning component 24 may be designed to provide impedance matching. For example, as the length L_{TUN} of tuning component 24 or the width W_{TUN} of tuning component 24 is increased, the reactance becomes more positive. Additionally, the amount of capacitive impedance provided by tuning component 24 may be adjusted by controlling a distance between the overlapping portions of radiating component 22 and tuning component 24, e.g., the thickness of substrate 29. In other words, the thickness of substrate 29 may also be used for tuning Although radiating component 22 and tuning component 24 overlap in the example RFID antenna 20 of FIG. 2, the techniques described herein are not limited to such an embodiment. In some instances, radiating component 22 and tuning component 24 may be offset such that the components are not substantially overlapping. In this case, radiating component 22 and tuning component 24 are still located proximal to one another to provide proximal coupling (e.g., via inductive or capacitive coupling) for transferring RF energy and providing tuning capabilities, but do not substantially overlap. In other words, there may be no overlap or only partial overlap between radiating component 22 and tuning component 24.

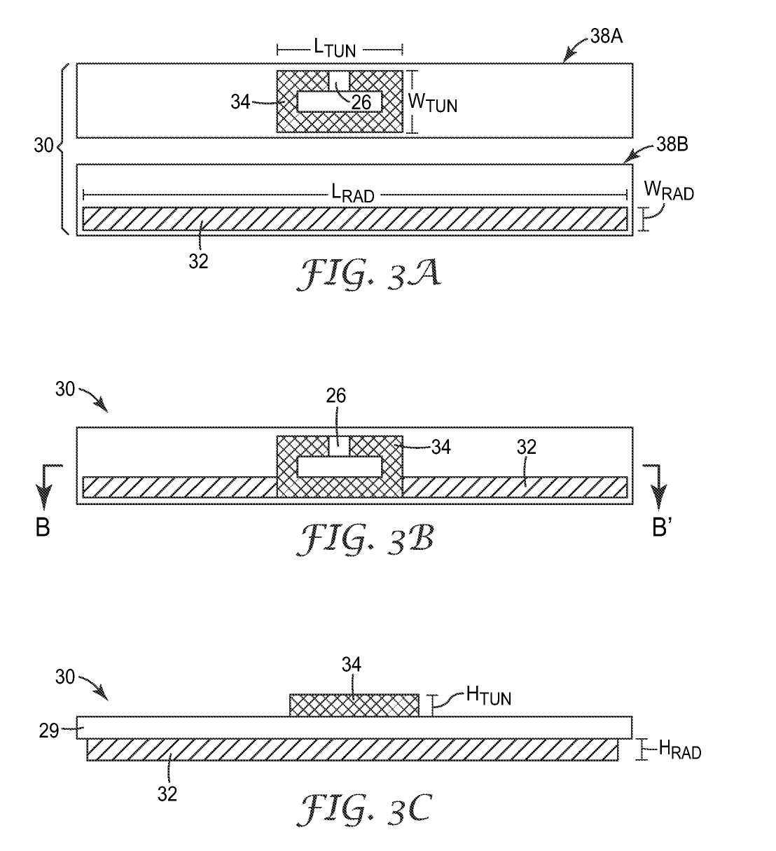

In accordance with one aspect of this disclosure, tuning component 24 and radiating component 22 are of different lengths so that any field radiated by tuning component 24 does not play a major role in the transmission and/or reception of radiation by RFID tag 20. Thus, the dominant source of radiation is still the straight dipole radiating component. For example, RFID tag 20 may be designed such that the field radiated by tuning element 24, if any, is less than 5 percent of the entire field radiated by RFID tag 20. By designing the tuning component 24 of RFID tag 20 to be less than one-quarter of the length of radiating component 22, and more preferably less than one-eighth of the length of radiating component 22, tuning component 24 may be designed to radiate a field within the limits provided above. The example RFID tag 20 illustrated in FIGS. 2A-2C is representative of one RFID tag configuration in accordance with this disclosure. The illustrated embodiment should not be limiting of the techniques as broadly described in this disclosure. For example, although tuning component 24 is positioned to overlap a center portion of radiating component 22, tuning component 24 may be offset from the center portion of radiating component 22. Moreover, tuning component 24 and radiating component 22 may be formed in different shapes, some of which are illustrated in FIGS. 3-6. Additionally, tuning component 24 may be constructed from multiple elements in addition to or instead of conductive traces. For example, tuning component may be made up of conductive traces and tuning capacitors. FIGS. 3A-3C are schematic diagrams illustrating an example RFID tag 30 that includes a radiating component 32 that inductively couples to a tuning component 34. FIG. 3A is an exploded view of RFID tag 30, FIG. 3B is a top view of RFID tag 30 and FIG. 3C is a cross section view of RFID tag 30 from B to B′. As illustrated in the exploded view of RFID tag 30 of FIG. 3A, RFID tag 30 includes a first layer 38A that includes tuning component 34 and a second layer 38B that includes radiating component 32. Radiating component 32 and tuning component 34 may be formed on opposite sides of a single substrate 29 or on separate substrates. Radiating component 32 and tuning component 34 may be formed using various fabrication techniques.

In the example RFID tag 30 illustrated in FIGS. 3A-3C, radiating component 32 is a straight dipole element that has a length L_{RAD} and a width W_{RAD} and tuning component 34 is a tuning loop that has a length L_{TUN} and a width W_{TUN}. The tuning loop illustrated in FIGS. 3A-3C is formed in the shape of a rectangle. The tuning loop may, however, take on different shapes. For example, the tuning loop may be formed in the shape of a half-circle, a half-oval, triangle, trapezoid or other symmetric or asymmetric shape.

Radiating component 32 and tuning component 34 are arranged such that there is substantial overlap between a portion of radiating component 32 and a portion of tuning component 34. When radiating component 32 and tuning component 34 are formed using conductive traces, at least a portion of the conductive traces (or traces) forming tuning component 34 substantially overlap with at least a portion of the conductive trace (or traces) forming radiating component 32. In the example top view illustrated in FIG. 3B, there is a substantial overlap between a portion of the length and width of radiating component 32 of second layer 38B and a length and width of one side of the tuning loop of tuning component 34 of first layer 38A. In other words, the portion of radiating component 32 of second layer 38B is located directly below the one side of the tuning loop that forms tuning component 34 on the first layer 38A. In the example illustrated in FIGS. 3A-3C, the side of the tuning loop of tuning component 34 that overlaps radiating component 32 is symmetrically located with respect to a center of radiating component 32. In other embodiments, however, the side of the tuning loop that overlaps radiating component 32 may be asymmetrically located with respect to the center of radiating component 32.

The overlap between the portion of radiating component 32 and the one side of the tuning loop of tuning component 34 provides inductive coupling. In particular, RF energy is transferred between the overlapping portions of tuning component 34 and radiating component 32 via a shared magnetic field. For example, as current flows through radiating component 32, a current is induced in the tuning loop of tuning component 34, thereby transferring RF energy from radiating component 32 to tuning component 34. In the embodiment illustrated in FIGS. 3A-3C, inductive coupling dominates because tuning component 34 is a closed loop through which current can easily flow. Although the coupling between the overlapping portions of radiating component 32 and tuning component 34 is predominately inductive coupling, the coupling may include at least some capacitive coupling as well.

The length L_{RAD} of radiating component 32 may, for example, be greater than approximately 100 mm (about 4 inches), and more preferably between approximately 130 mm and 180 mm (between about 5 and 7 inches), and even more preferably approximately 165 mm (slightly over 6.5 inches). The width W_{RAD} of the radiating component 32 may be less than approximately 4 mm (about 0.15 inches), and more preferably approximately 1 mm (about 0.04 inches).

The length L_{TUN} of tuning component 34 may be between approximately 10 mm and 50 mm (between about 0.4 and 2.0 inches), and more preferably between approximately 20 mm and 40 mm (between about 0.79 and 1.57 inches). The width W_{TUN} of the tuning component 34 may be less than approximately 6 mm (about 0.25 inches), and more preferably less than approximately 4 mm (about 0.15 inches). In one embodiment, width W_{TUN} of tuning component 34 may be less than or equal to approximately four times a width of conductive traces that form the tuning loop. In such an embodiment, the width of conductive traces forming the sides of the tuning loop are equal to 1X, and a space between an inside edge of the conductive trace forming the side of the tuning loop overlapping radiating component 32 and an inside edge of the conductive trace forming an opposite side of the tuning loop may be equal to approximately 2X, where X is equal to the conductive trace width. Thus, the width W_{TUN} of tuning component 34 may have a width that is approximately four times the width of the conductive traces forming the tuning loop. In another embodiment, the space between the inside edge of the conductive trace forming the side of the tuning loop overlapping radiating component 32 and the inside edge of the conductive trace forming an opposite side of the tuning loop may be equal to approximately 1X, resulting in a width that is approximately three times the width of the conductive traces. In some instances, the conductive traces that form tuning component 34 may have a minimum trace width of a selected manufacturing process, e.g., approximately 1 mm.

Again, the long, narrow aspect of radiating component 32 may allow RFID tag 30 to be concealed, i.e., rendered covert, on or within the article while still allowing RFID tag 30 to be interrogated even when partially covered by some object. For example, RFID tag 30 may be placed within a gutter of a book or on an inside portion of a spine of the book to conceal RFID tag 30 from an observer. RFID tag 30 may, however, still be interrogated when a hand of a person holding the book is partially covering RFID tag 30.

In addition to providing the coupling with radiating component 32, tuning component 34 may also provide impedance matching. In particular, the length L_{TUN} and the width W_{TUN} of tuning component 34, i.e., the tuning loop, may be adjusted to match an impedance of radiating component 32 and IC chip 26. For example, as the length L_{TUN} or width W_{TUN} of tuning component 34 is increased, the reactance becomes more positive. Additionally, the amount of inductive coupling between tuning component 34 and radiating component 32 may be adjusted by controlling a distance between the overlapping portions of radiating component 32 and tuning component 34, e.g., the thickness of substrate 29. In this manner, the thickness of substrate 29 may also be used for impedance matching (or tuning).

Matching an impedance of the antenna to the impedance of IC chip 26 improves transfer of RF energy between the interrogator and the RFID tag.

Although radiating component 32 and tuning component 34 overlap in the example RFID antenna 30 of FIG. 3, the techniques described herein are not limited to such an embodiment. In some instances, radiating component 32 and tuning component 34 may be offset such that the components are not substantially overlapping. In this case, radiating component 32 and tuning component 34 are still located proximal to one another to provide proximal coupling (e.g., via inductive or capacitive coupling) for transferring RF energy and providing tuning capabilities, but do not substantially overlap. In other words, there may be no overlap or only partial overlap between radiating component 32 and tuning component 34.

In accordance with one aspect of this disclosure, the dimensions of tuning component 34 are selected so that any field transmitted or received by tuning component 34 does not play a major role in the transmission and/or reception of radiation by RFID tag 30. Thus, the dominant source of radiation is still the straight dipole radiating element. For example, RFID tag 30 may be designed such that the field radiated by tuning component 34, if any, is less than 5 percent of the entire field radiated by RFID tag 30. By designing a circumference (or perimeter of tuning component 34 of RFID tag 30 to be less than one-quarter of the length of radiating component 32, and more preferably less than one-eighth of the length of radiating component 32, tuning component 34 may be designed to radiate a field within the limits provided above.

IC chip 26 may be electrically coupled to tuning component 34 via one or more feedpoints, e.g., bonding pads or other means for interconnection. IC chip 26 may be bonded to the feedpoints using flip chip bonding, wire bonding or the any other attachment mechanism.

As illustrated in FIGS. 3A and 3B, IC chip 26 couples to the tuning component 34 on the side of the tuning loop opposite from the side of the tuning loop that inductively couples to radiating component 32. However, IC chip 26 may couple to tuning component 34 on any side of the tuning loop, including the side that inductively couples to the radiating component 32.

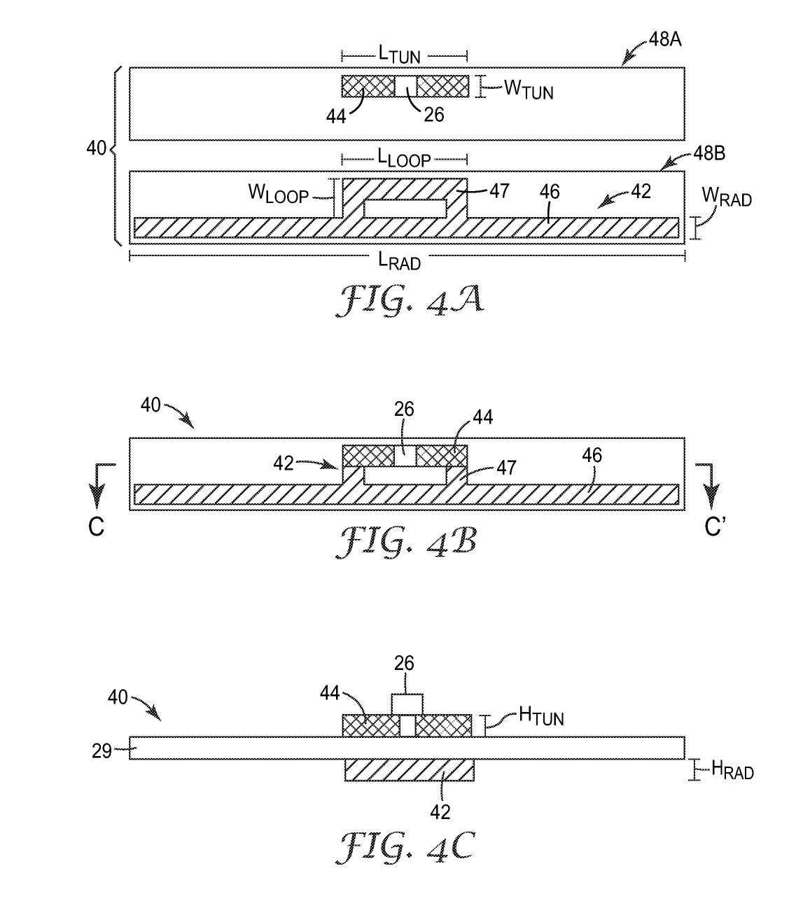

The example RFID tag 30 illustrated in FIGS. 3A-3C is representative of one RFID tag configuration in accordance with this disclosure. The illustrated embodiment should not be limiting of the techniques as broadly described in this disclosure. For example, although tuning component 34 is positioned to overlap a center portion of radiating component 32, tuning component 34 may be offset from the center portion of radiating component 32. Moreover, tuning component 34 and radiating component 32 may be formed in different shapes, some of which are illustrated in FIGS. 2 and 4-6. Additionally, tuning component 34 may be constructed from multiple elements in addition to or instead of conductive traces. For example, tuning component may be made up of conductive traces and tuning capacitors. FIGS. 4A-4C are schematic diagrams illustrating an example RFID tag 40 that includes a radiating component 42 that capacitively couples to a tuning component 44. FIG. 4A is an exploded view of RFID tag 40, FIG. 4B is a top view of RFID tag 40 and FIG. 4C is a cross section view of RFID tag 40 from C to C′. As illustrated in the exploded view of RFID tag 40 of FIG. 4A, RFID tag 40 includes a first layer 48A that includes tuning component 44 and a second layer 48B that includes radiating component 42. Radiating component 42 and tuning component 44 may be formed on opposite sides of a single substrate 29 or on separate substrates. Radiating component 42 and tuning component 44 may be formed using various fabrication techniques.

In the example RFID tag 40 illustrated in FIGS. 4A-4C, radiating component 42 includes a straight antenna segment 46 coupled to a conductive loop segment 47. In other words, radiating component 42 may be viewed as a straight dipole antenna with loop segment 47 added. In one embodiment, straight segment 46 and loop segment 47 may be electrically conductive traces disposed on substrate 29. For example, straight antenna segment 46 may be formed from a first electrically conductive trace and loop segment 47 may be formed of a second electrically conductive trace and coupled to the first conductive trace forming straight antenna segment 47.

Loop segment 47 of radiating component 42 illustrated in FIGS. 4A-4C is formed in the shape of a rectangle. Loop segment 47 of radiating component 42 may, however, take on different shapes. For example, loop segment 47 may be formed in the shape of a half-circle, a half-oval, triangle, trapezoid or other symmetric or asymmetric shape. Additionally, loop segment 47 is symmetrically located with respect to the straight segment 46. In other words, straight segment 46 extends an equal distance in both directions beyond loop segment 47. In other embodiments, however, loop segment 47 may be asymmetrically located with respect to the straight segment 46.

Radiating component 42 has a length L_{RAD} and a width W_{RAD}. The length L_{RAD} of radiating component 42 may, for example, be greater than approximately 100 mm (about 4 inches), and more preferably between approximately 140 mm and 180 mm (between about 5 and 7 inches), and even more preferably approximately 165 mm (slightly over 6.5 inches). The width W_{RAD} of the radiating component 42 may be less than approximately 6 mm (about 0.25 inches), and more preferably less than approximately 4 mm (about 0.15 inches).

In one embodiment, width W_{RAD} of radiating component 42 may be less than or equal to approximately four times a width of conductive traces that form loop segment 47. In such an embodiment, the width of conductive traces forming the sides of the tuning loop are equal to 1X, and a space between an inside edge of the conductive trace forming loop segment 47 and an inside edge of the conductive trace forming straight segment 46 may be equal to approximately 2X, where X is equal to the conductive trace width. Thus, the width W_{RAD} of radiating component 42 may have a width that is approximately four times the width of the conductive traces forming the tuning loop. In another embodiment, the space between the inside edge of the conductive trace forming loop segment 47 and the inside edge of the conductive trace forming straight segment 46 may be equal to approximately 1X, resulting in a width W_{RAD} that is approximately three times the width of the conductive traces. In some instances, the conductive traces that form tuning component 44 may have a minimum trace width of a selected manufacturing process, e.g., approximately 1 mm

Tuning component 44 is a straight tuning element that has a length L_{TUN} and a width W_{TUN}. The length L_{TUN} of tuning component 44 may be between approximately 10 mm and 50 mm (between about 0.4 and 2.0 inches), and more preferably between approximately 20 mm and 40 mm (between about 0.79 and 1.57 inches). The width W_{TUN} of the tuning component 44 may be less than approximately 4 mm (about 0.15 inches), and more preferably approximately 1 mm (about 0.04 inches). In one embodiment, tuning component 44 is formed from a conductive trace that has the same width as radiating component 42. Radiating component 42 and tuning component 44 are arranged such that there is substantial overlap between a portion of radiating component 42 and at least a portion of tuning component 44. In the example top view illustrated in FIG. 4B, there is a substantial overlap between a portion of loop segment 47 of radiation component 42 and a length and width of tuning component 44. In the example illustrated in FIGS. 4A-4C, tuning component 44 is symmetrically located with respect to center of the portion of loop segment 47. In other embodiments, however, tuning component 44 may be asymmetrically located with respect to the center of the portion of the loop segment 47, but still proximal to at least a portion of loop segment 47.

The overlap between the portion of loop segment 47 and tuning component 44 results in capacitive coupling between tuning component 44 and radiating component 42. In this manner, tuning component 44 transfers RF energy between radiating component 42 with IC chip 26. In one example, a conductive trace forming tuning component 44 may act as a first capacitive plate and the portion of loop segment 47 that overlaps tuning component 44 may act as a second conductive plate. An electric field exists between the overlapping conductive traces to provide the capacitive coupling between tuning component 44 and radiating component 42. In general, the more overlapping surface area between radiating component 42 and tuning component 44, the larger the tuning capacitance. The amount of overlap may be controlled, for example, by adjusting a length and/or width of tuning component 44 or the positioning of tuning element 44 with respect to the radiating element 42. Although the predominant coupling between radiating component 22 and tuning component 24 of RFID antenna 20 is capacitive, the coupling may include at least some inductive coupling as well. In addition to providing the coupling with radiating component 42, tuning component 44 may also provide impedance matching. In particular, the length L_{TUN} and the width W_{TUN} of tuning component 44 may be adjusted to match an impedance of radiating component 42 and IC chip 26. For example, as the length L_{TUN} and/or width W_{TUN} of tuning component 44 is increased, the reactance becomes more positive. Additionally, the distance between the overlapping portions of radiating component 42 and tuning component 44, e.g., the thickness of substrate 29, may further be used to control the tuning capacitance. Matching an impedance of the antenna to the impedance of IC chip 26 improves transfer of RF energy between the interrogator and the RFID tag. Although the predominant coupling between radiating component 42 and tuning component 44 of RFID tag 40 is capacitive, the coupling may include at least some inductive coupling as well.

The antenna may further be tuned to match the impedance of IC chip 26 by modifying dimensions of loop segment 47. For example, a length or width of the loop segment 47 may be adjusted to match the impedance of the antenna to the impedance IC chip 26.

Additionally, a number of aspects of loop segment 47 may also be modified to improve the operation of RFID tag 40. For example, a length of the loop segment may be adjusted to affect the sensitivity of RFID tag 40. A longer length L_{LOOP} may increase the sensitivity of RFID tag 40 to signal interference, loss caused by the presence of dielectric material (e.g., pages and other binding materials) and changes in dipole length. Alternatively, or additionally, the shape of loop segment 47 may also be adjusted to affect sensitivity of RFID tag 42.

Although radiating component 42 and tuning component 44 overlap in the example RFID antenna 40 of FIG. 4, the techniques described herein are not limited to such an embodiment. In some instances, radiating component 42 and tuning component 44 may be offset such that the components are not substantially overlapping. In this case, radiating component 42 and tuning component 44 are still located proximal to one another to provide proximal coupling (e.g., via inductive or capacitive coupling) for transferring RF energy and providing tuning capabilities, but do not substantially overlap. In other words, there may be no overlap or only partial overlap between radiating component 42 and tuning component 44.

In accordance with one aspect of this disclosure, the dimensions of tuning component 44 are selected so that any field transmitted or received by tuning component 44 does not play a major role in the transmission and/or reception of radiation by RFID tag 40. Thus, the dominant source of radiation is still the straight dipole radiating element. For example, RFID tag 40 may be designed such that the field radiated by tuning element 44, if any, is less than 5 percent of the entire field radiated by RFID tag 40. By designing the tuning component 44 of RFID tag 40 to be less than one-quarter of the length of radiating component 42, and more preferably less than one-eighth of the length of radiating component 42, tuning component 44 may be designed to radiate a field within the limits provided above.

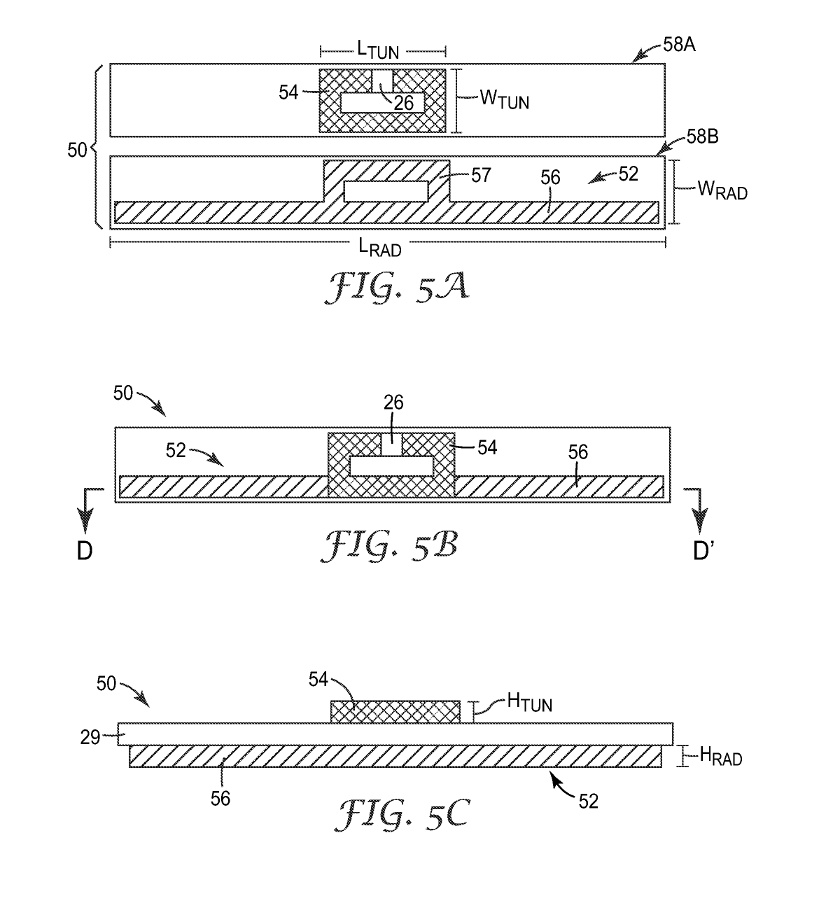

The example RFID tag 40 illustrated in FIGS. 4A-4C is representative of one RFID tag configuration in accordance with this disclosure. The illustrated embodiment should not be limiting of the techniques as broadly described in this disclosure. For example, although tuning component 44 is positioned to overlap a center portion of radiating component 42, tuning component 44 may be offset from the center portion of radiating component 42. Moreover, tuning component 44 and radiating component 42 may be formed in different shapes, some of which are illustrated in FIGS. 2, 3, 5 and 6. Additionally, tuning component 44 may be constructed from multiple elements in addition to or instead of conductive traces. For example, tuning component may be made up of conductive traces and tuning capacitors. FIGS. 5A-5C are schematic diagrams illustrating an example RFID tag 50 that includes a radiating component 52 that inductively couples to a tuning component 54. FIG. 5A is an exploded view of RFID tag 50, FIG. 5B is a top view of RFID tag 50 and FIG. 5C is a cross section view of RFID tag 50 from D to D′. As illustrated in the exploded view of RFID tag 50 of FIG. 5A, RFID tag 50 includes a first layer 58A that includes tuning component 54 and a second layer 58B that includes radiating component 52. Radiating component 52 and tuning component 54 may be formed on opposite sides of a single substrate 29 or on separate substrates. Radiating component 52 and tuning component 54 may be formed using various fabrication techniques.

In the example RFID tag 50 illustrated in FIGS. 5A-5C, radiating component 52 that has a length L_{RAD} and a width W_{RAD}. Radiating component includes a straight antenna segment 56 coupled to a conductive loop segment 57. In other words, radiating component 52 may be viewed as a straight dipole antenna with loop segment 57 added. In one embodiment, straight segment 56 and loop segment 57 may be electrically conductive traces disposed on substrate 29. Tuning component 54 is a tuning loop that has a length L_{TUN} and a width W_{TUN}.

Loop segment 57 of radiating component 52 and the tuning loop of tuning component 54 are formed in the shape of a rectangle in the illustrated example. Loop segment 57 and tuning component 54 may, however, take on different shapes. For example, loop segment 57 may be formed in the shape of a half-circle, a half-oval, triangle, trapezoid or other symmetric or asymmetric shape. Loop segment 57 and the tuning loop may be of the same shape or different shapes.

The length L_{RAD} of radiating component 52 may, for example, be greater than approximately 100 mm (about 5 inches), and more preferably between approximately 150 mm and 180 mm (between about 5 and 7 inches), and even more preferably approximately 165 mm (slightly over 6.5 inches). The length L_{TUN} of tuning component 54 may be between approximately 10 mm and 50 mm (between about 0.5 and 2.0 inches), and more preferably between approximately 20 mm and 40 mm (between about 0.79 and 1.57 inches).

The width W_{RAD} of the radiating component 52 and the width W_{TUN} of tuning component 54 may be less than approximately 6 mm (about 0.25 inches), and more preferably less than approximately 5 mm (about 0.15 inches). As described above, the width W_{RAD} of radiating component 52 and the width W_{TUN} of tuning component 54 may, in some instances, be less than or equal to approximately four times a width of conductive traces that form loop segment 57 and the tuning loop, respectively. The conductive traces that form tuning component 54 may have a minimum trace width of a selected manufacturing process, e.g., approximately 1 mm. Although illustrated in FIGS. 5A-5C as being approximately the same width, radiating component 52 and tuning component 54 may have different widths.

Radiating component 52 and tuning component 54 are arranged such that there is substantial overlap between a portion of radiating component 52 and at least a portion of tuning component 54. In the example top view illustrated in FIG. 5B, there is a substantial overlap between loop segment 57 of radiation component 52 and the tuning loop of tuning component 54. Alternatively, only a portion of loop segment 57 may overlap the tuning loop of tuning component 54.

The overlap between loop segment 57 and the tuning loop of tuning component 54 results in inductive coupling between radiating component 52 and tuning component 54. In particular, RF energy is transferred between the overlapping portions of tuning component 54 and radiating component 52 via a shared magnetic field. For example, as current flows through loop segment 57 of radiating component 52, a current is induced in the tuning loop of tuning component 54, thereby transferring RF energy from radiating component 52 to tuning component 54. In the embodiment illustrated in FIGS. 5A-5C, inductive coupling dominates because tuning component 54 is a closed loop through which current can easily flow. Although the coupling between the overlapping portions of radiating component 54 and tuning component 54 is predominately inductive coupling, the coupling may include at least some capacitive coupling as well.

In addition to providing the coupling with radiating component 52, tuning component 54 may also provide impedance matching. In particular, the length L_{TUN} and the width W_{TUN} of tuning component 54, i.e., the tuning loop, may be adjusted to match an impedance of radiating component 52 and IC chip 26. For example, as the length L_{TUN} and/or width W_{TUN} of tuning component 54 is increased, the reactance becomes more positive. Additionally, the distance between the overlapping portions of radiating component 52 and tuning component 54, e.g., the thickness of substrate 29, may further be used to control the tuning capacitance. Matching an impedance of the antenna to the impedance of IC chip 26 improves transfer of RF energy between the interrogator and the RFID tag.

The antenna may further be tuned to match the impedance of IC chip 26 by modifying dimensions of loop segment 57 of radiating component 52. For example, a length or width of the loop segment 57 may be adjusted to match the impedance of the antenna to the impedance of IC chip 26. Additionally, a number of aspects of loop segment 57 may also be modified to improve the operation of RFID tag 50. For example, a length of the loop segment may be adjusted to affect the sensitivity of RFID tag 50. A longer length L_{LOOP} may increase the sensitivity of RFID tag 50 to signal interference, loss caused by the presence of dielectric material (e.g., pages and other binding materials) and changes in dipole length. Alternatively, or additionally, the shape of loop segment 57 may also be adjusted to affect sensitivity of RFID tag 52.

Although radiating component 52 and tuning component 54 overlap in the example RFID antenna 50 of FIG. 5, the techniques described herein are not limited to such an embodiment. In some instances, radiating component 52 and tuning component 54 may be offset such that the components are not substantially overlapping. In this case, radiating component 52 and tuning component 54 are still located proximal to one another to provide proximal coupling (e.g., via inductive or capacitive coupling) for transferring RF energy and providing tuning capabilities, but do not substantially overlap. In other words, there may be no overlap or only partial overlap between radiating component 52 and tuning component 54.

In accordance with one aspect of this disclosure, the dimensions of tuning component 54 are selected so that any field transmitted or received by tuning component 54 does not play a major role in the transmission and/or reception of radiation by RFID tag 50. Thus, the dominant source of radiation is still the straight dipole radiating element. For example, RFID tag 50 may be designed such that the field radiated by tuning element 54, if any, is less than 5 percent of the entire field radiated by RFID tag 50. For example, by designing a circumference or perimeter of tuning component 54 of RFID tag 50 to be less than one-quarter of the length of radiating component 52, and more preferably less than one-eighth of the length of radiating component 52, tuning component 54 may be designed to radiate a field within the limits provided above.

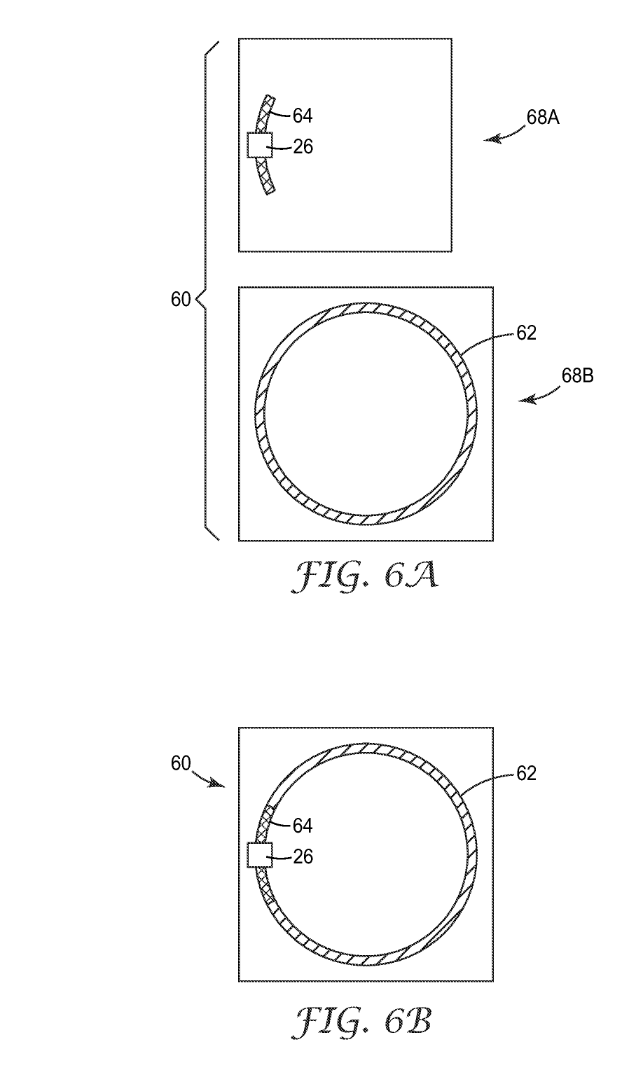

The example RFID tag 50 illustrated in FIGS. 5A-5C is representative of one RFID tag configuration in accordance with this disclosure. The illustrated embodiment should not be limiting of the techniques as broadly described in this disclosure. For example, although tuning component 54 is positioned to overlap a center portion of radiating component 52, tuning component 54 may be offset from the center portion of radiating component 52. Moreover, tuning component 54 and radiating component 52 may be formed in different shapes, some of which are illustrated in FIGS. 2-4 and 6. Additionally, tuning component 54 may be constructed from multiple elements in addition to or instead of conductive traces. For example, tuning component may be made up of conductive traces and tuning capacitors. FIGS. 6A and 6B are schematic diagrams illustrating an example RFID tag 60 that includes a radiating component 62 that capacitively couples to a tuning component 64. FIG. 6A is an exploded view of RFID tag 60 and FIG. 6B is a top view of RFID tag 60. As illustrated in the exploded view of RFID tag 60 of FIG. 6A, RFID tag 60 includes a first layer 68A that includes tuning component 64 and a second layer 68B that includes radiating component 62. Radiating component 62 and tuning component 64 may be formed on opposite sides of a single substrate or on separate substrates using various fabrication techniques.

In the example RFID tag 60 illustrated in FIGS. 6A and 6B, radiating component 62 is a loop antenna. The loop antenna illustrated in FIGS. 6A and 6B includes a single loop that is shaped like a circle. In other embodiments, however, the loop antenna may have more than one loop. Additionally, the loop antenna may take on different shapes, e.g., an oval shape, a rectangular shape, a square shape, a trapezoid shape or other symmetric or asymmetric shape. Radiating component 62 includes a length L_{RAD} and a width W_{RAD}. In the example illustrated in FIGS. 6A and 6B, the length L_{RAD} of radiating component 62 is the circumference of the circle-shaped loop. The circle-shaped loop of radiating component 62 may have a circumference that is approximately half of a wavelength. In one example, the circle-shaped loop of radiating component 62 may have a radius of approximately 22 mm (about 0.87 inches). Thus, the length L_{RAD} of radiating component 62 is approximately 138 mm (about 5.43 inches). The width W_{RAD} of radiating component 62 may be a thickness of the conductive trace or other conductive element that forms the loop, which may be less than approximately 4 mm (about 0.15 inches), and more preferably approximately 1 mm (about 0.04 inches).

Tuning component 64 is an arc segment that has a length L_{TUN} and a width W_{TUN}. The arc segment that forms tuning component 64 may be a portion of a loop of the same radius as the loop antenna forming radiating component 62. In one example, the arc segment may be approximately one-eighth of the portion of a loop of the same radius. In this example, the length L_{TUN} of the tuning component 64 is approximately 17.25 mm (about 0.68 inches). IC chip 26 is electrically coupled to tuning component 62.

Radiating component 62 and tuning component 64 are arranged such that there is substantial overlap between a portion of radiating component 62 and tuning component 64. In the example top view illustrated in FIG. 6B, there is a substantial overlap between radiating component 62 and tuning component 64 along a portion of the circumference of radiating component 62. The substantial overlap between tuning component 64 and radiating component 62 provides capacitive coupling between tuning component 64 and radiating component 62 for transferring RF energy, e.g., RF signals, between radiating component 62 and an IC chip 26 that is electrically coupled to the tuning component 64. Although the predominant coupling between radiating component 62 and tuning component 64 of RFID antenna 60 is capacitive, the coupling may include at least some inductive coupling as well. Tuning component 64 may also provide improved impedance matching between an impedance of radiating component 62 and IC chip 26. Tuning component 64 may provide a resistance and reactance to match the impedance of the antenna to the impedance of IC chip 26. In particular, the length L_{TUN} and the width W_{TUN} of tuning component 64 may be designed to provide impedance matching. For example, as the length L_{TUN} and/or the width W_{TUN} of tuning component 64 is increased, the reactance becomes more positive.

Additionally, the distance between the overlapping portions of radiating component 62 and tuning component 64, e.g., the thickness of substrate 29, may further be used to control the tuning capacitance.

Although radiating component 62 and tuning component 64 overlap in the example RFID antenna 60 of FIG. 6, the techniques described herein are not so limited. In some instances, radiating component 62 and tuning component 64 may be offset such that the components are not substantially overlapping. In this case, radiating component 62 and tuning component 64 are still located proximal to one another to provide proximal coupling (e.g., via inductive or capacitive coupling) for transferring RF energy and providing tuning capabilities, but do not substantially overlap. In other words, there may be no overlap or only partial overlap between radiating component 62 and tuning component 64.

In accordance with one aspect of this disclosure, tuning component 64 is significantly smaller than radiating component 62 so that any field radiated by tuning component 64 does not play a major role in the transmission and/or reception of radiation by RFID tag 60. Thus, the dominant source of radiation is still the loop antenna. For example, RFID tag 60 may be designed such that the field radiated by tuning element 64, if any, is less than 5 percent of the entire field radiated by RFID tag 60. By designing the tuning component 64 of RFID tag 60 to be less than one-quarter of the length of radiating component 62, and more preferably less than one-eighth of the length of radiating component 62, tuning component 64 may be designed to radiate a field within the limits provided above.

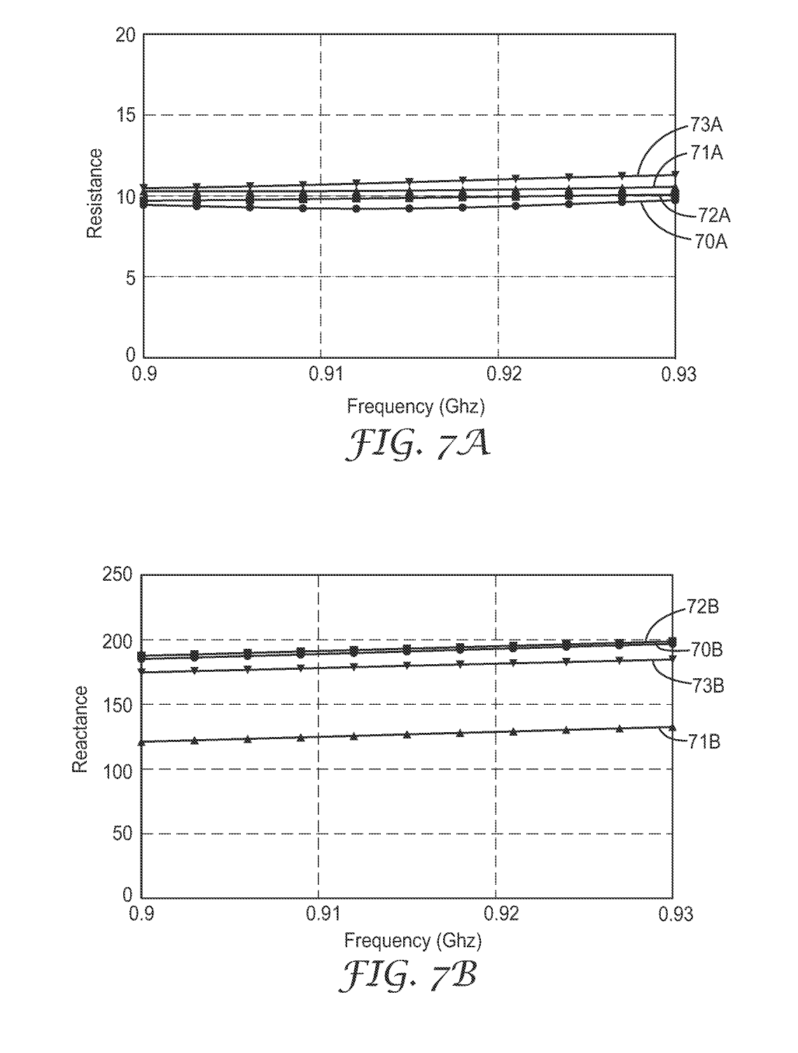

The example RFID tag 60 illustrated in FIGS. 6A-6C is representative of one RFID tag configuration in accordance with this disclosure. The illustrated embodiment should not be limiting of the techniques as broadly described in this disclosure. For example, although tuning component 64 is positioned to overlap a center portion of radiating component 62, tuning component 64 may be offset from the center portion of radiating component 62. Moreover, tuning component 64 and radiating component 62 may be formed in different shapes, some of which are illustrated in FIGS. 2-5. Additionally, tuning component 64 may be constructed from multiple elements in addition to or instead of conductive traces. For example, tuning component may be made up of conductive traces and tuning capacitors. FIGS. 7A and 7B are graphs showing the impedance of RFID tag 30 of FIG. 3, RFID tag 40 of FIG. 4, RFID tag 50 of FIG. 5 and a reference RFID tag over the 900 to 930 MHz range. The reference RFID tag was constructed on a single side of the substrate and included a straight dipole segment and a loop segment, similar to radiating components 42 and 52 of FIGS. 4 and 5, respectively.

Resistance curve 70A corresponds with RFID tag 30, resistance curve 71A corresponds with RFID tag 40, resistance curve 72A corresponds with RFID tag 50 and resistance curve 73A corresponds with the reference RFID tag. The RFID tags tested had a length L_{RAD} of 165 mm, a trace width of 1 mm, a length L_{TUN} of 26 mm, and a spacing between an inside edge of the conductive trace forming the sides of the loop of 2 mm. Reactance curve 70B corresponds with RFID tag 30, reactance curve 71B corresponds with RFID tag 40, reactance curve 72B corresponds with RFID tag 50 and reactance curve 73B corresponds with the reference RFID tag. As illustrated in the graphs of FIG. 7A, the real part of the impedance, i.e., the resistance, of RFID tags 30, 40, 50 showed little change from the real part of the impedance of the reference RFID tag over the UHF RFID band of interest (900-930 MHz). As illustrated in the graphs of FIG. 7B, the imaginary part of the impedance, i.e., the reactance, of RFID tags 30 and 50 showed little change from the imaginary part of the impedance of the reference RFID tag over the UHF RFID band of interest (900-930 MHz). However, the imaginary part of the impedance of RFID tag 40 showed an increase in capacitance that causes the imaginary component of the impedance to be reduced over the UHF RFID band. The impedance of RFID tag 40 may further be adjusted by adjusting the overlapped region and/or the length of the tuning loop of radiating component 42. As such, tuning component 44 may be useful in matching the impedance of the antenna with the impedance of IC chip 26.

Table 1 illustrates empirical results of the various RFID tag designs. Table 1 represents changes in impedance as the length of the tuning component (i.e., L_{TUN}) was adjusted. Again, the reference tag design was a single layer modified dipole antenna that included a straight dipole segment and a loop segment, similar to radiating components 42 and 52 of FIGS. 4 and 5, respectively.

TABLE 1

| | Length of tuning | Impedance |
|---|---|---|
| Tag design | component (mm) | (Ohms) |
| Reference | 32 | 52 + j158 |
| RFID tag 20 | 28 | 4.3 − j60 |
| | 57 | 164 + j97 |
| RFID tag 30 | 26 | 34 + j132 |
| | 32 | 47 + j158 |
| | 38 | 75 + j191 |
| RFID tag 40 | 26 | 36 + j8 |
| | 32 | 52 + j48 |
| | 38 | 82 + j70 |
| RFID tag 50 | 26 | 29 + j135 |
| | 32 | 39 + j170 |
| | 38 | 34 + j228 |

As illustrated in the table, the impedance of the tuning component with a loop segment length of 32 mm is 52+j158. For RFID tag 20 of FIG. 2, the capacitive coupling between radiating component 22 and tuning component 24 increases as the length of the overlapping region increases, e.g., as the length L_{TUN} of tuning component 24 increases. In particular, when the straight segment that forms tuning element 24 increases from 28 mm to 57 mm, the impedance changes from 4.3−j60 to 164+j97. In this manner, the tuning element may provide additional elements for tuning without increasing a footprint of RFID tag 20. For RFID tag 30 of FIG. 3, the inductive coupling between radiating component 32 and tuning component 34 increases as the length of the overlapping region increases, e.g., as the length L_{TUN} of tuning component 34 increases. Likewise, for RFID tag 50 of FIG. 5, the inductive coupling between radiating component 52 and tuning component 54 increases as the length of the overlapping region increases. As such, tuning component 35, 54 of RFID tag 30, 50 may provide additional elements for tuning the imaginary component to a higher value.

For RFID tag 40 of FIG. 4, the capacitive coupling between radiating component 42 and tuning component 44 increases as the length of the overlapping region increases, e.g., as the length L_{TUN} of tuning component 44 increases. Increasing the region of overlap will cause the overlap area to act as one unit piece of metal and thus the increase should asymptotically approach the impedance of the reference case. This can be seen by the increase in the imaginary component as the over lap increases. In this manner, tuning component 44 of RFID tag 40 may provide an additional element for tuning the imaginary component to a higher value.

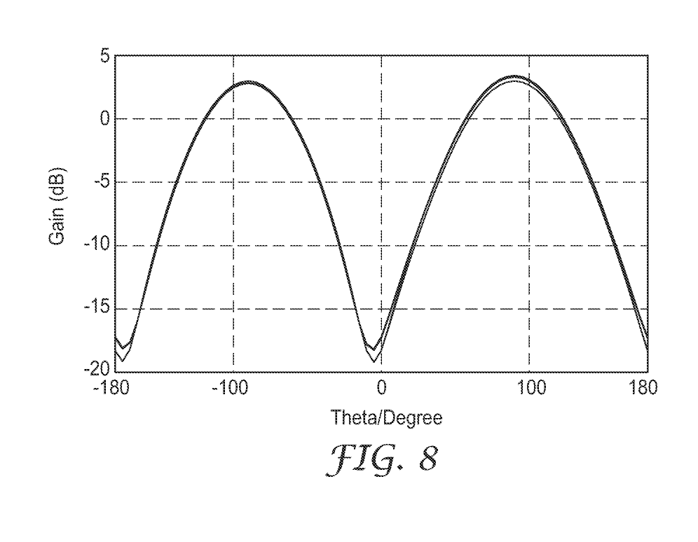

FIG. 8 is a graph illustrating gains of various RFID tag designs to illustrate radiation characteristics of the various RFID tag designs. FIG. 8 shows radiation characteristics (e.g., gains) of four RFID tag designs; RFID tag 30 of FIG. 3, RFID tag 40 of FIG. 4, RFID tag 50 of FIG. 5 and a reference RFID tag. The reference RFID tag was a single layer modified dipole antenna that included a straight dipole segment and a loop segment, similar to radiating components 42 and 52 of FIGS. 4 and 5, respectively. The two peaks illustrated in FIG. 8 are characteristic of a dipole type antenna.

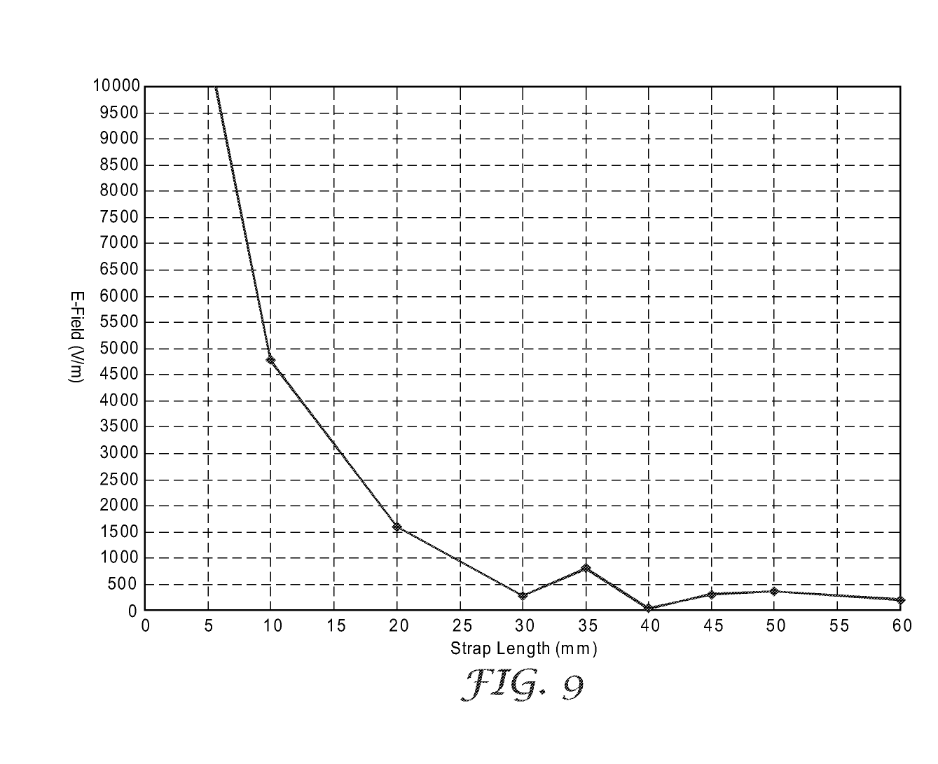

As illustrated in FIG. 8, the radiation characteristics for each of the RFID tag designs are substantially the same, as the lines of the separate RFID tag designs are nearly indistinguishable. In other words, although there are four separate lines each representing one of the RFID tag designs, the radiation characteristics of each RFID tag design are so similar that the four lines appear as substantially one line. Thus, the radiation characteristics of the RFID tags 30, 40 and 50 that have a radiating component on one layer and a tuning component on a second layer continue to have radiation characteristics are substantially the same as the single-sided modified dipole reference antenna. As such, the tag designs of RFID tag 30, 40 and 50 are advantageous because not only do they have the same radiation characteristics of the reference antenna, but include tuning components that may provide additional inductance and/or capacitance for tuning purposes to further improve performance. FIG. 9 is a graph illustrating example fields radiated by RFID tag 30 of FIG. 3 and a straight dipole antenna. In particular, the graph of FIG. 9 shows two example fields; a first field radiated by RFID tag 30 of FIG. 3 and a second field radiated by a straight dipole antenna. As described in detail in FIG. 3, RFID tag 30 includes a radiating component 32 that is a straight dipole element and a tuning component 34 that is a tuning loop. As shown in the graph of FIG. 9, the resulting fields radiated by RFID tag 30 of FIG. 3 is substantially the same magnitude as the field radiated by the reference straight dipole antenna, indicating that the field radiated by tuning component 34 does not play a major role in transmission and/or reception of radiation by RFID tag 30. In fact, the magnitude of the field radiated by RFID tag 30 and the straight dipole antenna are so similar that they appear as a single line. In other words, although there are two separate lines illustrated in FIG. 9, the lines are so similar that they appear as a single line.

The graph of FIG. 9 was obtained by performed modeling in which an excitation voltage was placed on tuning component 34 until a current with a magnitude of one amp was flowing on tuning component 34. The current flowing on radiating component 32 was determined. Next, the electric field produced by the entire structure of RFID tag 30 with one amp current flowing on tuning component 34 was determined at a fixed far-field distance. Then, tuning component 34 was removed and a source was placed at the center of the straight dipole antenna of the reference RFID tag. A magnitude of the voltage source was adjusted to produce the same current as was induced by tuning component 34. The resulting electric field produced by the straight dipole antenna was determined at a fixed far-field distance. Again, the results illustrated in FIG. 9 indicated that tuning component 34 does not play a major role in transmission and/or reception of radiation by RFID tag 30. Therefore, tuning component 34 simply provides a mechanism to connect IC chip 26 to the radiating component 32 without affecting radiating properties of RFID tag 30

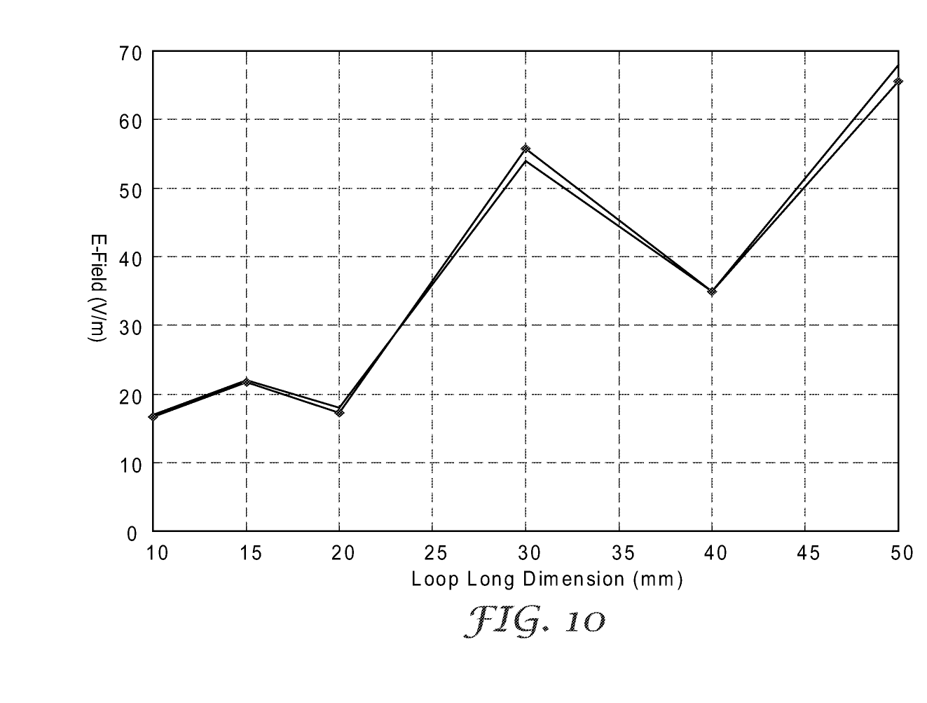

FIG. 10 is a graph illustrating example fields radiated by RFID tag 50 of FIG. 5 and a reference modified dipole antenna. As described in detail in FIG. 5, RFID tag 50 includes a radiating component 52 that includes a straight dipole segment 56 and a loop segment 57, and a tuning component 54 that is a tuning loop. The reference antenna was a modified dipole antenna similar that is substantially the same as radiating component 52, but with no tuning component 54. As shown in the graph of FIG. 10, the resulting fields radiated by RFID tag 50 of FIG. 50 is substantially the same magnitude as the field radiated by the reference modified dipole antenna, thus indicating that the field radiated by tuning component 54 does not play a major role in transmission and/or reception of radiation by RFID tag 50. The largest difference, which is only 2-3 V/m, occurs at the peaks at L_{TUN} lengths of 30 and 50 mm.

The graph of FIG. 10 was obtained by modeling performed as described above with respect to FIG. 9. Again, the results illustrated in FIG. 10 indicated that tuning component 54 does not play a major role in transmission and/or reception of radiation by RFID tag 50.

Therefore, tuning component 54 simply provides a mechanism to connect IC chip 26 to the radiating component 52 without affecting radiating properties of RFID tag 50.

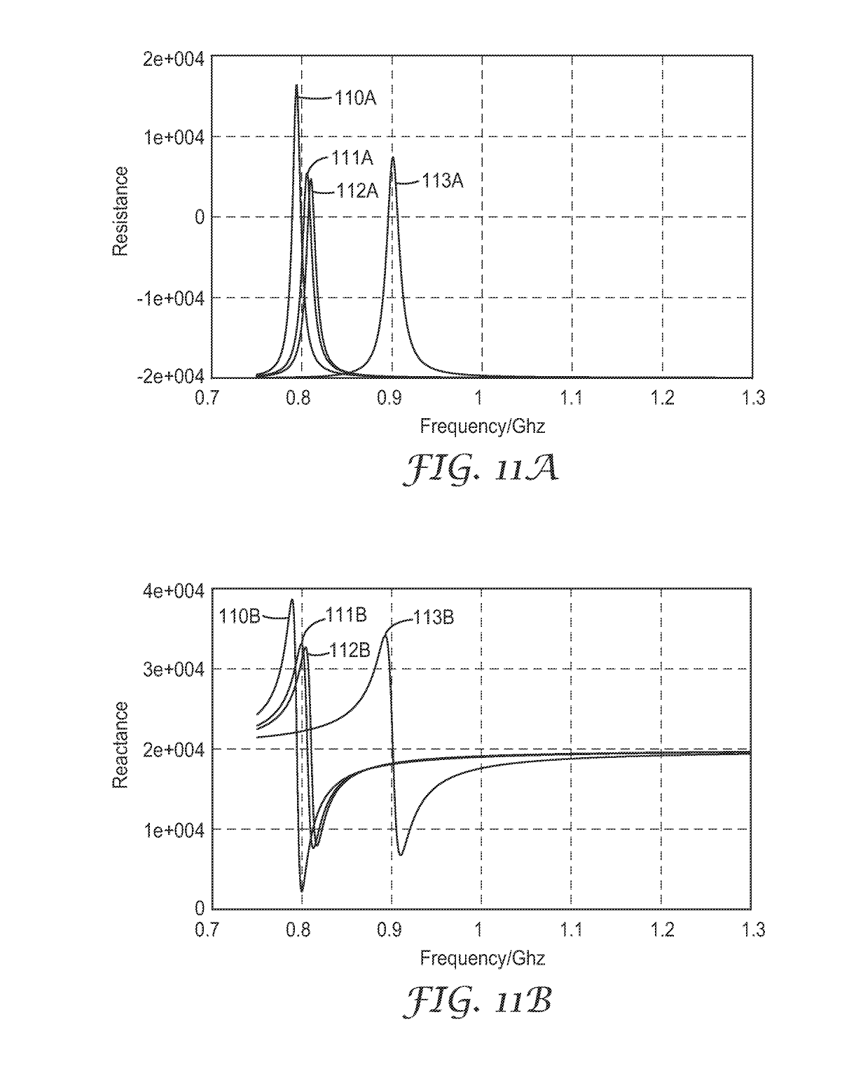

FIGS. 11A and 11B are graphs demonstrating the impedance of RFID tag 60 of FIG. 6 and a reference RFID tag. As described in detail above, RFID tag 60 had a radiating component 62 that is a circle-shaped conductive loop and tuning component 64 is an arc segment of a portion of a circle-shaped loop of the same radius. The reference RFID tag had the same geometry as the radiating component 62 of RFID tag 60, i.e., circle-shaped loop, but with no tuning component 64 on a second layer. The amount of overlap corresponds with a length of the arc segment forming tuning component 64. RFID tag 60 and the reference RFID tag were modeled using CST Microwave Studios. These loop antennas have a radius of 22 mm. Resistance curve 110A corresponds with arc segment forming tuning component 64 having a length of 26 mm, resistance curve 111A corresponds with arc segment forming tuning component 64 having a length of 32 mm, resistance curve 112A corresponds with arc segment forming tuning component 64 having a length of 38 mm and resistance curve 113A corresponds with the reference RFID tag with no tuning component 64. As illustrated in the graphs, the impedance can be tuned using the capacitively coupled overlap between tuning component 64 and radiating component 62. As the length of the overlap increased, the impedance comes closer to approximating the reference design.

Various embodiments have been described. The embodiments described are described for purposes of limitation and, therefore, should not be limiting. Other designs may be encompassed within the scope of this disclosure. For example, the radiating component may be a multi-layer radiating component. In other words, portions of the radiating component may be formed on different layers of the RFID tag and be coupled using vias or using capacitive/inductive coupling. In this case, the tuning element may be located on a different layer of the RFID tag than the portions of the radiating component, and be arranged to overlap with at least a portion of the radiating component of the other layers. These and other embodiments are within the scope of the following claims.

1. A radio frequency identification (RFID) tag comprising:
a radiating component formed on a first layer of a substrate, wherein the radiating component includes a straight dipole segment and a loop segment that is electrically coupled to the straight dipole segment;
a tuning component formed on a second layer of the substrate, wherein at least a portion of the tuning component substantially overlaps a portion of the radiating component of the first layer of the substrate to couple to the radiating component; and
an integrated circuit (IC) that electrically couples to the tuning component.

2. The RFID tag of claim 1, wherein the tuning component comprises a straight conductive segment that overlaps a portion of the radiating component to capacitively couple to the radiating component.

3. The RFID tag of claim 2, wherein the tuning component overlaps a portion of the loop segment of the radiating component to capacitively couple to the radiating component.

4. The RFID tag of claim 2, wherein the tuning component overlaps a portion of the straight dipole segment of the radiating component to capacitively couple to the radiating component.

5. The RFID tag of claim 1, wherein the tuning component comprises a tuning loop that overlaps the loop segment of the radiating component to inductively couple to the radiating component.

6. The RFID tag of claim 1, wherein a length of the tuning component is less than approximately one-quarter of a length of the radiating component.

7. The RFID tag of claim 6, wherein the length of the tuning component is less than approximately one-eighth of the length of the radiating component.

8. The RFID tag of claim 1, wherein a field radiated by the tuning component is less than approximately 5 percent of a combined field radiated by both the radiating component and the tuning component.

9. The RFID tag of claim 1, wherein:
a width of the radiating component is less than approximately 6 millimeters (mm) and
a length of the radiating component is greater than approximately 100 mm; and
a width of the tuning component is less than approximately 6 mm and a length of the tuning component is less than approximately 40 mm.

10. The RFID tag of claim 9, wherein the width of the radiating component and the width of the tuning component is less than or equal to approximately 4 mm.

11. The RFID tag of claim 1, wherein the RFID tag is configured to operate in an ultra high frequency (UHF) band of the radio frequency spectrum.

12. An antenna for a radio frequency identification (RFID) tag comprising:
a radiating component formed on a first layer of a substrate, wherein the radiating component includes a straight dipole segment and a loop segment that is electrically coupled to the straight dipole segment; and
a tuning component formed on a second layer of the substrate, wherein at least a portion of the tuning component substantially overlaps a portion of the radiating component of the first layer of the substrate to couple to the radiating component.

13. The antenna of claim 12, wherein the tuning component comprises a straight conductive segment that overlaps a portion of the radiating component to capacitively couple to the radiating component.

14. The antenna of claim 13, wherein the tuning component overlaps a portion of the loop segment of the radiating component to capacitively couple to the radiating component.

15. The antenna of claim 13, wherein the tuning component overlaps a portion of the straight dipole segment of the radiating component to capacitively couple to the radiating component.

16. The antenna of claim 12, wherein the tuning component comprises a tuning loop that overlaps the loop segment of the radiating component to inductively couple to the radiating component.

17. The antenna of claim 12, wherein a length of the tuning component is less than approximately one-quarter of a length of the radiating component.

18. The antenna of claim 17, wherein the length of the tuning component is less than approximately one-eighth of the length of the radiating component.

19. The antenna of claim 12, wherein a field radiated by the tuning component is less than approximately 5 percent of a combined field radiated by both the radiating component and the tuning component.

20. The antenna of claim 12, wherein:
a width of the radiating component is less than approximately 6 millimeters (mm) and
a length of the radiating component is greater than approximately 100 mm; and
a width of the tuning component is less than approximately 6 mm and a length of the tuning component is less than approximately 40 mm.

21. The antenna of claim 20, wherein the width of the radiating component and the width of the tuning component is less than or equal to approximately 4 mm.

22. The antenna of claim 12, wherein the RFID tag is configured to operate in an ultra high frequency (UHF) band of the radio frequency spectrum.

23. A radio frequency identification (RFID) tag comprising:
a radiating component formed on a first layer of a substrate;
a tuning component formed on a second layer of the substrate, wherein at least a portion of the tuning component is proximal to the tuning; and
an integrated circuit (IC) that electrically couples to the tuning component.

24. The RFID tag of claim 23, wherein the tuning component comprises a conductive segment that is proximal to a portion of the radiating component to capacitively couple to the radiating component.

25. The RFID tag of claim 23, wherein a portion of the radiating component is a loop.

26. The RFID tag of claim 25, wherein the tuning component is proximal to a portion of the loop to capacitively couple to the radiating component.
